(19) United States
(12) Patent Application Publication
(10) Pub. No.: US 2004/0210676 A1
(43) Pub. Date: Oct. 21, 2004

(54) System for Calculating minimum images to service customer orders

(76) Inventor: Gary Patrick Noto, Austin, TX (US)

Correspondence Address: HAMILTON & TERRILE, LLP, P.O. BOX 203518, AUSTIN, TX, 78720, US

(21) Appl. No.: 10/419,308

(22) Filed: Apr. 19, 2003

(51) Int. Cl. G06F 3/00

(52) U.S. Cl. 710/1

(57) ABSTRACT

A method for minimizing a number of images needed to install software parts. The method includes identifying a unique combination of software parts, determining a number of base part combinations to service the unique combination of software parts, and generating images stacks to correspond to the number of base part combinations.

### BACKGROUND OF THE INVENTION

1. Field of the Invention

The present invention relates to the field of identifying unique software orders and more particularly to identifying a minimum number of images to service a customer order.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more information handling systems, data storage systems, and networking systems.

It is known to install software and to perform tests on information handling systems before they are shipped to businesses or individual customers. A goal of software installation is to efficiently produce a useful, reliable information handling system. Software installation often includes loading a desired package or combination of packages of software onto the information handling system, preparing appropriate environment variables for the computer, preparing appropriate environment variables for the computer, and preparing appropriate initialization files for the loaded software.

When installing hardware and software onto multiple information handling systems in a manufacturing environment, identifying a unique software or hardware order across multiple information handling systems is desirable. A software order is unique if all the software parts and parameters that are installed in a system are unique in combination. A hardware order is unique when all of the hardware parts of that order are unique in combination.

One aspect of identifying unique software order relates to identifying a number of software images used to service customer orders.

### SUMMARY OF THE INVENTION

In one embodiment, the invention relates to a method for minimizing a number of images needed to install software parts. The method includes identifying a unique combination of software parts, determining a number of base part combinations to service the unique combination of software parts, and generating images stacks to correspond to the number of base part combinations.

In another embodiment, the invention relates to an apparatus for minimizing a number of images needed to install software parts. The apparatus includes means for identifying a unique combination of software parts, means for determining a number of base part combinations to service the unique combination of software parts, and means for generating images stacks to correspond to the number of base part combinations.

In another embodiment, the invention relates to an information handling system for minimizing a number of images needed to install software parts which includes a processor and a memory coupled to the processor. The memory storing modules are for identifying a unique combination of software parts, determining a number of base part combinations to service the unique combination of software parts, and generating images stacks to correspond to the number of base part combinations.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a block diagram of a plurality of manufacturing sites providing information relating to orders.

FIG. 3 shows a flow chart of the operation of a system for identifying unique orders.

FIG. 4 shows a block diagram showing sets of images corresponding to matching orders.

FIG. 5 shows a block diagram showing aspects of unique order information across particular business units within a manufacturer.

FIG. 6 shows a flow chart of the system for calculating minimum images to service customer orders.

FIG. 7 shows a system block diagram of an information handling system having a unique order configuration.

### DETAILED DESCRIPTION

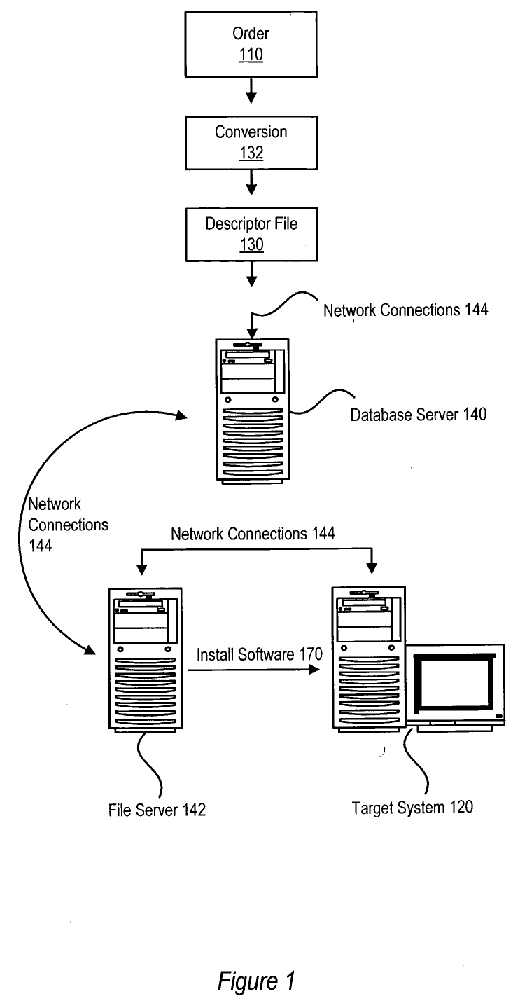

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before a target information handling system 120 is shipped to the customer, the plurality of components are installed and tested.

The software may include one or more base parts. There may be many base part combinations that are installed onto target information handling systems. A base part may be an operating system, a language or an uninstallable application or combination of applications (such as, for example, the Microsoft Office suite). It is desirable to have a unique image stack for each combinations of base parts.

Because different families of information handling systems and different individual computer components require different software installation, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 110 using an image of the software that is stored on the database server 140.

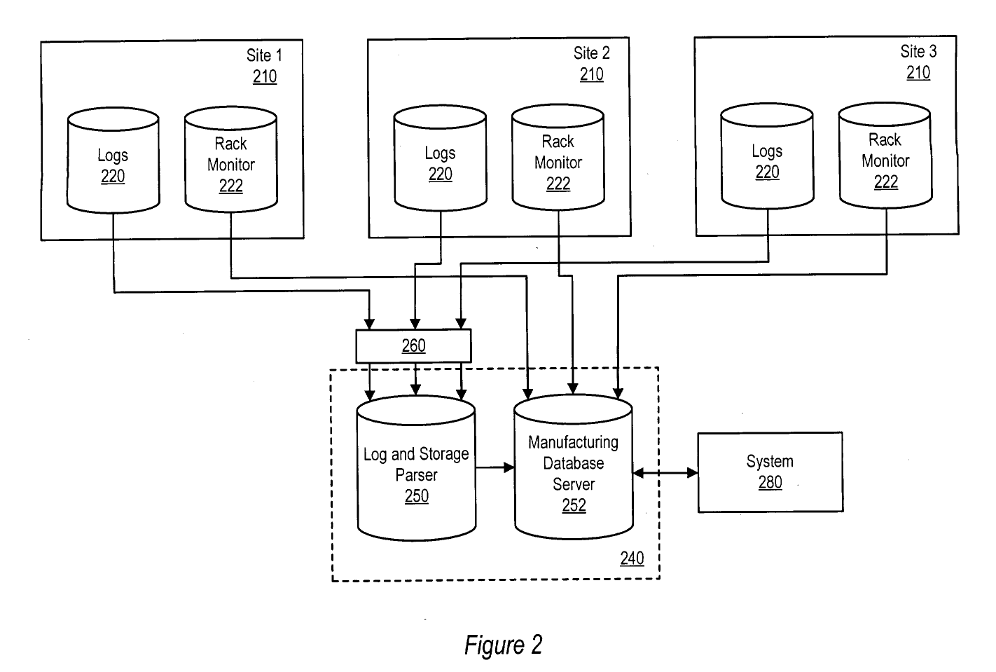

Referring to FIG. 2, a block diagram of a plurality of manufacturing sites providing information relating to orders is shown. More specifically, the plurality of manufacturing sites 210 each include a respective log database 220 and burn rack monitor database 222. Information from the log databases 220 and the burn rack monitor databases 222 are provided to an order storage system 240. The order storage system includes a log storage and parser server 250 and a manufacturing database server 252. The log storage and parser server 250 and the manufacturing database server 252 may be located on one or more servers. The log storage and parser server 250 receives information from the log databases 220 and the manufacturing database server 252 receives information from the burn rack monitor database 222. The information that is provided to the log storage and parser database 250 passes through a system for calculating and identifying unique orders 260.

The system for calculating and identifying unique orders 260 packages a plurality of different system configurations in a unique and easily identifiable identifier. Providing a unique and easily identifiable identifier for each unique order configuration enables analysis of the order configuration to determine the frequency of certain order configurations as well as ranking of certain order configurations. Such identification and ranking enables pre-combination of certain commonly ordered configurations so as to expedite the manufacturing and loading process.

The manufacturing system also includes a system for calculating minimum images to service customer orders 280. The system for calculating minimum images to service customer orders 280 calculates and identifies the combinations of base parts that exist in a set of records and maintains all parts taken against that image stack within the historical record set by the user. The system for calculating minimum images to service customer orders 280 identifies an actual number of calculated image stacks along with an estimate of the size of the image stack based upon the size of existing zip and script files. Accordingly, the system for calculating minimum images to service customer orders 280 identifies the number of images stacks needed to service orders and the size of each of these stacks. The system for calculating minimum images to service customer orders 280 further calculates part take rates (i.e., the number of times a particular combination of parts is ordered and thus installed on target systems) and overall image size for each calculated image stack.

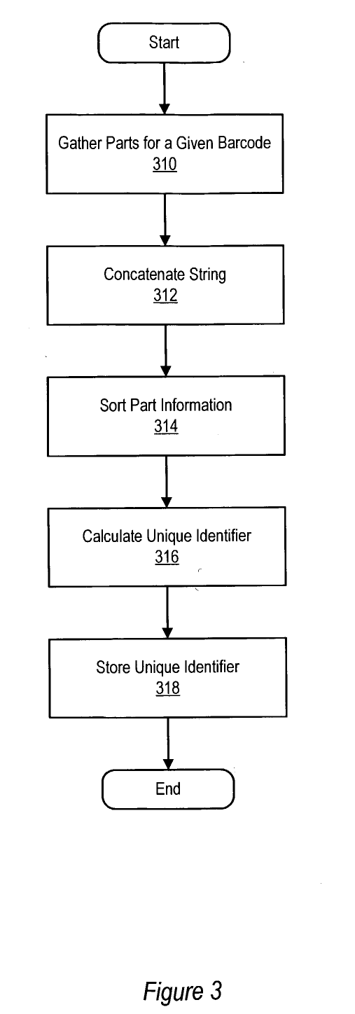

Referring to FIG. 3, a flow chart of the operation of the system for calculating and identifying unique orders 260 is shown. More specifically, the system for calculating and identifying unique orders 260 starts operation by gathering the part information for a given system barcode at step 310. The part information includes software part information and hardware part information. The software part information includes the software part (referred to as an SRV) and a part number that functions as a passed parameter to a software part (referred to as the infopart) for the software. The SRV may identify the software part as a base part. Inforparts perform functional variations based upon the existence of an inforpart in the order. The hardware part information includes the item, the sequence number and the detailed description of the hardware. The sequence number represents the slot of the hardware part. The sequence number is present when more than one of the same hardware component is present in a system (e.g., more than one hard drive, memory chip NIC card, etc. in a system)

After the part information is gathered at step 310, then the system concatenates a string containing all of the part information for a given order type at step 312. The given order type includes hardware order information, software order information, informational order information and base part order information. More specifically, the software order information includes the SRV of the order, the information order information includes the infopart, the hardware order information includes the item, sequence number and detailed description and the base part order information includes images of the SRVs contained within the base parts list.

After the string is concatenated at step 312, the string of part information is sorted at step 314. The string of part information is sorted by any known consistent sorting routine such that the part information is presented in a consistent order across the part information records.

After the string of part information is sorted at step 314, a unique order information value is calculated for the sorted string of part information. The unique order information value is calculated, for example, by calculating a unique integer for each type of unique order information. More specifically, a cyclical redundancy checking (CRC) algorithm is applied to the sorted part information and an integer value is provided by the algorithm.

The CRC algorithm may be any known CRC algorithm. Known CRC techniques ensure the accuracy of transmitting digital data. The transmitted digital data messages are divided into predetermined lengths which, used as dividends, are divided by a fixed divisor. The remainder of the calculation is appended onto and sent with the message. Upon receipt of the transmitted digital data message, the remainder is recalculated. If the remainder does not match the transmitted remainder, an error is detected. In the preferred embodiment, the CRC algorithm is used to calculate a unique order information value which reflects unique sorted part information.

After the unique order information value is calculated, this value is stored within the manufacturing database server 252 at step 318. The unique order information value is associated with an associated barcode. Storing the unique information value in the database server 252 at the barcode level facilitates and speeds analysis of groupings, averages, sums etc. of the unique order information because the number of records in the groups is significantly less at the barcode level than at the individual part per barcode level.

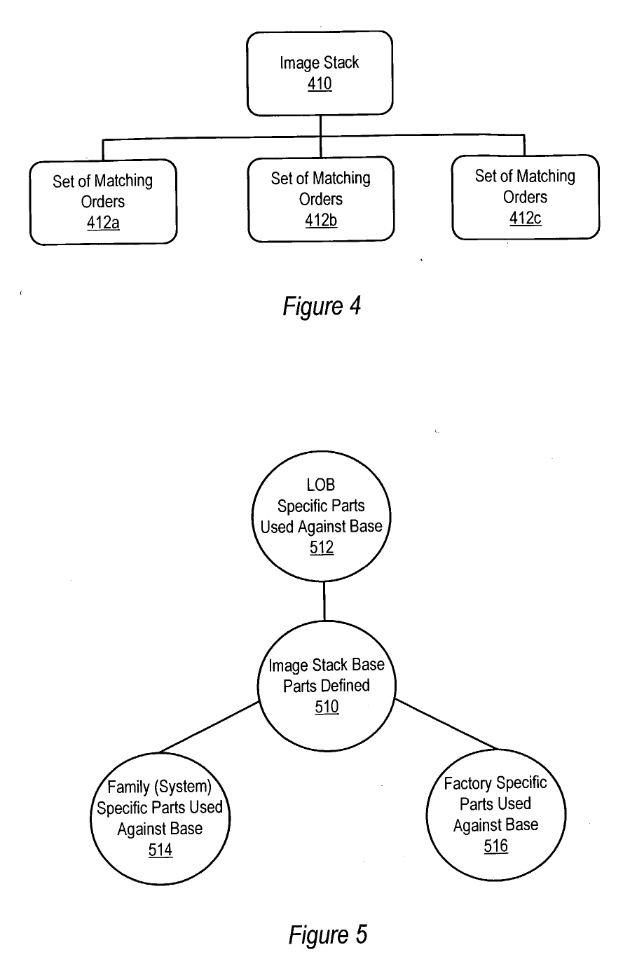

Referring to FIG. 4, a block diagram showing sets of images corresponding to matching orders is shown. More specifically, one aspect of the unique order information relates to the various aspects of a software that are combined to represent the software portion of the order. Once the software parts are identified, an image stack 510 is generated which corresponds to the combination of software parts. Within this image stack, there are a plurality of sets of matching orders 512a, 512b, 512c. Each of these matching orders has the same software parts ordered as identified by the unique order information. Using the unique order information, the unique combinations of software parts may be identified and images including these combinations of software parts may be more easily generated.

The system 280 analyzes the unique part number information to identify certain subsets of parts that have certain qualities. For example, software parts that are not installable may reduce the set up time when the system is first powered on. Examples of this type of software part include the operating system, a suite of programs such as the Microsoft Office suite or the Microsoft Works suite. Analyzing these combinations allow these combinations to be preconfigured, thereby reducing the setup time of the target information handling system. Such a system 280 also enables a manufacturer to prioritize testing to spend more time on the combinations of parts that are most frequently ordered. Identifying the minimum images enables identification of the smallest number of images that may be loaded together.

Referring to FIG. 5, a block diagram of aspects of unique order information across particular business units within a manufacturer is shown. More specifically, a manufacturer may divide orders among a plurality of different characterizations. When a manufacturer is so organized, it becomes even more important to be able to identify matching orders of images.

For example, a manufacturer may have line of business (LOB) specific parts characterization 612, family (i.e., system) specific parts characterization 614, and factory specific parts characterization 618. The line of business specific parts characterization 612 may represent lines of business such as home, small business, large business, etc. Each of these lines of business may have unique combinations of parts that are installed on their respective manufactured systems. Family specific parts characterization may be related to other parts of the system. For example, a particular hardware part might dictate a need for a particular type of software part to be installed. Factory specific parts characterizations might also provide unique combinations of software parts. For example, one factory might manufacture systems that are intended for certain languages. The language might dictate a need for a particular type of software part to be installed.

Each of the specific parts characterization types are then combined within the manufacturer to provide a master stack base part definition. Each of the other specific part characterization types are then used and compared against this master stack base part definition. Once a unique order is identified within a specific part characterization, this unique order may then be used within the other specific parts characterization.

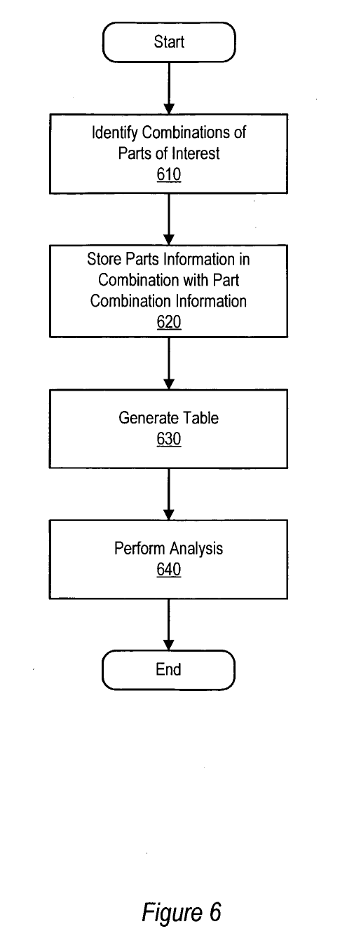

Referring to FIG. 6, a flow chart of the system for calculating minimum images to service customer orders 280 is shown. More specifically, the system 280 calculates a unique identifier based on a unique combination of parts of interest (base parts) during step 610. These base parts are post configured (i.e., already setup) bits of the customer installation in the image that is installed on the target system.

Next part numbers are stored in combination with the base part being analyzed at step 620. While the base combinations are identical across customer segments (lines of business), factories, regions, systems etc, those part numbers can vary depending on the context of the systems being analyzed. Thus, the part numbers being stored in combination with the base part combination enables a complete analysis based upon the context of the systems analyzed.

Next, a table is generated at step 630 which allows for the calculation of part take rates for a given base part combination to allow the context to vary against the same post configured base image stack. Thus, the system 280 enables the illusion of many different static images for the same base parts which can further post configure parts of high take rate or have parts that are subtracted from (i.e., uninstalled) from the base image.

Next, a two fold analysis is generated when an end user requests a specific context for systems at step 640. More specifically, first the list of all base part combinations with their associated take rates is generated based upon the existence of a base part combination number in the database. Second, a given base part number combination can list all software parts used in conjunction with the base part combination with an associated take rate for each of the software parts.

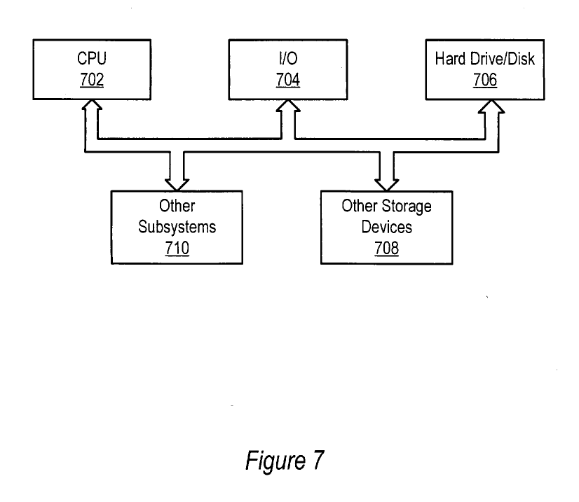

Referring to FIG. 7, a system block diagram of an information handling system 700 which has parts installed which are identified by the unique order information is shown. The information handling system includes a processor 702, input/output (I/O) devices 704, such as a display, a keyboard, a mouse, and associated controllers, a hard disk drive 706, and other storage devices 708, such as a floppy disk and drive and other memory devices, and various other subsystems 710, all interconnected via one or more buses 712. The software that is installed according to the unique order information methodology is installed onto hard disk drive 706. Alternately, the software may be installed onto any appropriate non-volatile memory. The non-volatile memory may also store the information relating to which unique parts were installed on the information handling system. Accessing this information enables a user to have additional systems corresponding having the unique part combinations to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

### OTHER EMBODIMENTS

Other embodiments are within the following claims.

Also for example, the above-discussed embodiments include software modules that perform certain tasks. The software modules may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for minimizing a number of images needed to install software parts, comprising:
identifying a unique combination of software parts;
determining a number of base part combinations to service the unique combination of software parts; and,
generating images stacks to correspond to the number of base part combinations.

2. The method of claim 1, wherein:
the base part is at least one of an operating system, a language and an uninstallable application.

3. The method of claim 1, further comprising:
calculating a take rate of the unique combination of software parts.

4. The method of claim 3, further comprising
varying the image stack based upon the take rate of the unique combination of software parts .

5. The method of claim 1, wherein
a given order type includes software part order information and base part order information.

6. The method of claim 1, wherein:
the identifying a unique combination of software parts includes calculating a unique order information value includes applying a cyclical redundancy checking (CRC) algorithm to part information data to generate a CRC value corresponding to the part information data.

7. The method of claim 6, wherein:
the CRC value corresponding to the part information data is stored within a manufacturing database server.

8. The method of claim 1, further comprising
analyzing part number information to identify certain subsets of software parts having certain qualities.

9. The method of claim 8, further comprising
the certain qualities include whether the software parts are installable.

10. The method of claim 8, further comprising ‘preconfiguring certain unique combinations of software parts based upon the analyzing.

11. An apparatus for minimizing a number of images needed to install software parts, comprising:
means for identifying a unique combination of software parts;
means for determining a number of base part combinations to service the unique combination of software parts; and,
means for generating images stacks to correspond to the number of base part combinations.

12. The apparatus of claim 11, wherein:
the base part is at least one of an operating system, a language and an uninstallable application.

13. The apparatus of claim 11, further comprising:
means for calculating a take rate of the unique combination of software parts.

14. The apparatus of claim 13, further comprising
means for varying the image stack based upon the take rate of the unique combination of software parts.

15. The apparatus of claim 11, wherein
a given order type includes software part order information and base part order information.

16. The apparatus of claim 11, wherein:
the means for identifying a unique combination of software parts includes means for calculating a unique order information value includes applying a cyclical redundancy checking (CRC) algorithm to part information data to generate a CRC value corresponding to the part information data.

17. The apparatus of claim 16, wherein:
the CRC value corresponding to the part information data is stored within a manufacturing database server.

18. The apparatus of claim 11, further comprising
means for analyzing part number information to identify certain subsets of software parts having certain qualities.

19. The apparatus of claim 18, wherein
the certain qualities include whether the software parts are installable.

20. The apparatus of claim 18, further comprising
means for preconfiguring certain unique combinations of software parts based upon the analyzing.

21. An information handling system for minimizing a number of images needed to install software parts, comprising:
a processor;
a memory coupled to the processor, the memory storing modules for:
identifying a unique combination of software parts;
determining a number of base part combinations to service the unique combination of software parts; and,
generating images stacks to correspond to the number of base part combinations.
